(19) United States
(12) Patent Application Publication
(10) Pub. No.: US 2018/0156623 A1
(43) Pub. Date: Jun. 7, 2018

(54) GENERATING TRAVEL INSTRUCTIONS IN MULTIMODAL TRANSPORTATION SCENARIOS

(71) Applicant: Microsoft Technology Licensing, LLC, Redmond, WA (US)

(72) Inventors: Jeff West, Sammamish, WA (US); Ana Lilia Otero Diaz, Woodinville, WA (US); Elizabeth P. Salowitz, Seattle, WA (US); Kshitij Mehta, Bothell, WA (US); David Grochocki, JR., Seattle, WA (US)

(21) Appl. No.: 15/369,648

(22) Filed: Dec. 5, 2016

(51) Int. Cl. G01C 21/34; G06Q 30/06; G06Q 50/30

(52) U.S. Cl. CPC G01C 21/3423; G01C 21/3492; G06Q 50/30; G06Q 30/0611; G01C 21/3484

(57) ABSTRACT

A user provides a request for a ride sharing service that includes an origin location and a destination location. It is determined whether the origin location is associated with a condition that may lead to a high cost or a high wait for the ride. These conditions may include traffic or events that are near the origin location, or conditions such as surge pricing. In response to determining the condition, alternative locations are selected. These alternative locations may be locations that are generally on the way to the destination location, but that are not associated with the condition. A walking speed of the user is used with fare and time information from the ride sharing service about the locations to select a location that optimizes cost or waiting time for the user. The location may be recommended to the user, and a vehicle may be dispatched to the location.

### BACKGROUND

Applications, such as map applications, let users search for directions using a variety of transportation modes such as walking, driving, and public transportation. With respect to public transportation, when a user enters a query for directions including an origin location and a destination location, the map application gives the user a list of the routes that can be used to reach the destination location, and an indication of the closest stop to the origin location. In addition, the map application may give the user some indication of when the public transportation mode will arrive at the closest stop. While such information is useful, because the map application does not know how fast the user typically walks, the map application cannot give an accurate estimate of when the user should leave their house to reach the stop to avoid missing the ride and to avoid waiting at the stop. Moreover, the map application cannot recognize when conditions, such as weather or traffic, make a stop other than the closest stop preferable to the user.

Ride sharing applications also fail to consider multiple modes of transportation when considering trips. Typically, users of ride sharing services enter a request for a ride that includes an a origin location and a destination location. By default, the origin location is the current location of the user. The ride sharing application then dispatches a vehicle to the origin location of the user, and the vehicle takes the user to the destination location.

While such ride sharing applications are convenient, often users are forced to wait for the dispatched vehicle. This is particularly problematic when the user is at a location associated with traffic or congestion. In such circumstances, had the user been instructed to walk to a location that is outside of the traffic or congestion, the user may have been able to avoid the wait, and the overall cost and length of the trip in the vehicle may have been reduced. Moreover, a user may prefer to walk some portion of the trip, rather than use the vehicle for the entire trip. However, there currently exists no way to alert the user that an alternative pick-up location is recommended, or to select such an alternative location to the specified origin based on traffic conditions and/or based on preferences of the user.

### SUMMARY

A user provides a request for a ride sharing service that includes an origin location and a destination location. It is determined whether the origin location is associated with a condition that may lead to a high cost or a high wait for the ride. These conditions may include traffic or events that are near the origin location, or conditions such as surge pricing. In response to determining the condition, alternative locations are selected. These alternative locations may be locations that are generally on the way to the destination location, but that are not associated with the condition. For example, a location may be considered generally on the way to the destination location when the distance between the location and the destination location is not greater than the distance between the origin location and the destination location by some predetermined or adjustable threshold percentage (e.g., 1%, 5%, 10%, etc.). A walking speed of the user is used along with fare and time information from the ride sharing service about the locations to select a location that optimizes cost or waiting time for the user. The location may be recommended to the user, and a vehicle may be dispatched to the location.

In an implementation, a system for minimizing wait times or costs for a user in multimodal transportation scenarios is provided. The system may include at least one computing device and a route engine. The route engine may be adapted to: receive a request for transportation from a device, wherein the request includes an origin location and a destination location; determine a plurality of locations based on the origin location and the destination location, wherein each location of the plurality of locations is accessible from the origin location using a first transportation mode and the destination location is accessible from each location of the plurality of locations using a second transportation mode; based in part on a user profile, select a location of the plurality of locations; and present instructions to travel to the selected location from the origin location using the first transportation mode and instructions to travel to the destination location from the selected location using the second transportation mode.

In an implementation, a system for minimizing wait times for a user in multimodal transportation scenarios is provided. The system may include at least one computing device and a route engine. The route engine may be adapted to: receive a request for transportation, wherein the request includes an origin location and a destination location; determine a plurality of locations based on the origin location and the destination location, wherein each location of the plurality of location is accessible from the origin location using a first transportation mode and the destination location is accessible from each location of the plurality of locations using a second transportation mode; retrieve a user profile; for each of each location of the determined locations, determine an arrival time at the location for a vehicle using the second transportation mode; for each location of the determined locations, determine an arrival time of the user at the location using the first transportation mode based on information from the user profile; select a location of the plurality of locations based on the arrival times of the user and the arrival times of the vehicles; and present an offer based on the selected location, wherein the offer is for the user to travel from the origin location to the selected location using the first transportation mode and to travel from the selected location to the destination location using the second transportation mode.

In an implementation, a method for minimizing wait times and costs for a user in multimodal transportation scenarios is provided. The method may include: receiving a request for transportation by a computing device, wherein the request includes an origin location and a destination location; determining a plurality of locations based on the origin location and the destination location by the computing device, wherein each location of the plurality of location is accessible from the origin location using a first transportation mode and the destination location is accessible from each location of the plurality of locations using a second transportation mode; retrieving a user profile by the computing device; for each location of the determined locations, determining an arrival time at the location for a vehicle using the second transportation mode and a cost for a trip from the location to the destination location by the computing device; for each location of the determined locations, determining an arrival time of the user at the location using the first transportation mode based on information from the user profile by the computing device; selecting a location of the plurality of locations based on the arrival times of the user, the arrival times of the vehicle, and the costs by the computing device; and presenting an offer based on the selected location, wherein the offer is for the user to travel from the origin location to the selected location using the first transportation mode and to travel from the selected location to the destination location using the second transportation mode.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for minimizing wait times or costs for users in multimodal transportation scenarios;

FIG. 2 is an illustration of an implementation of an exemplary route engine;

FIG. 3 is an example of a user-interface through which a user can submit requests for transportation;

FIG. 4 is an example of a user-interface through which a user can submit requests for transportation;

FIG. 5 is an example of a user-interface through which a user can submit requests for transportation;

FIG. 6 is an example of a user-interface through which a user can submit requests for transportation;

FIG. 7 is an operational flow of an implementation of a method for presenting instructions in response to a request for transportation;

FIG. 8 is an operational flow of an implementation of a method for presenting instructions in response to a request for transportation;

FIG. 9 is an operational flow of an implementation of a method for presenting an offer in response to a request for transportation; and

FIG. 10 shows an exemplary computing environment in which example embodiments and aspects may be implemented.

### DETAILED DESCRIPTION

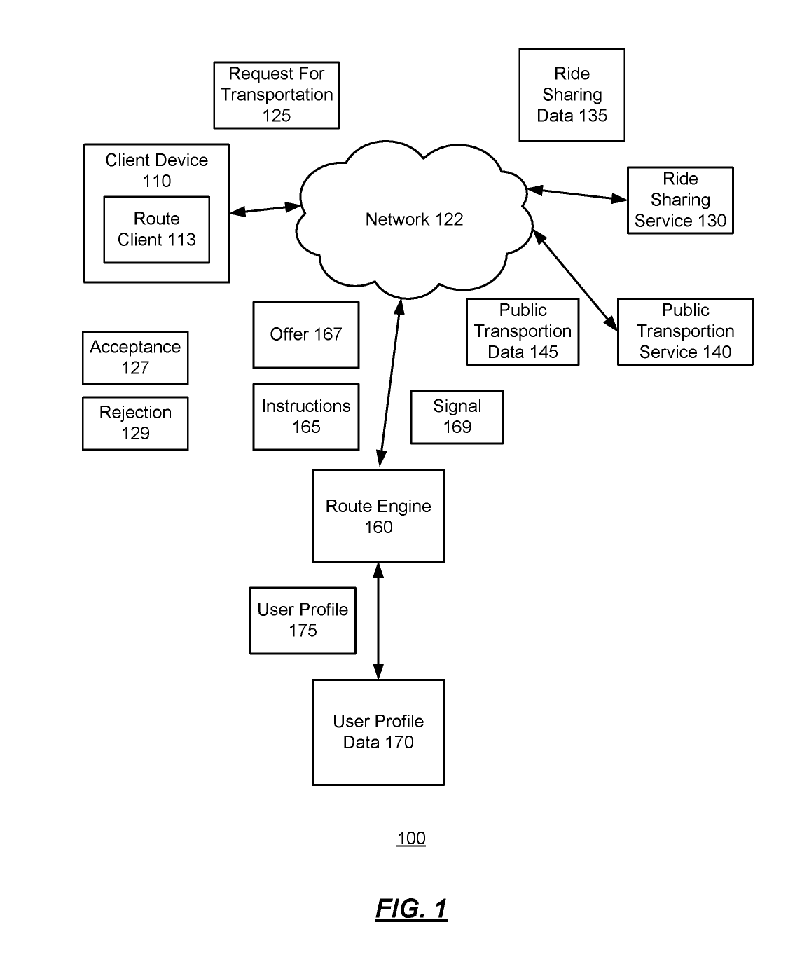

FIG. 1 is an illustration of an exemplary environment 100 for minimizing wait times or costs for users in multimodal transportation scenarios. The environment 100 may include a route engine 160, a client device 110, and one of more of a ride sharing service 130 and a public transportation service 140 in communication through a network 122. The network 122 may be a variety of network types including the public switched telephone network (PSTN), a cellular telephone network, and a packet switched network (e.g., the Internet). Although only one client device 110, one route engine 160, one ride sharing service 130, and one public transportation service 140 are shown in FIG. 1, there is no limit to the number of client devices 110, route engines 160, ride sharing services 130, and public transportation services 140 that may be supported.

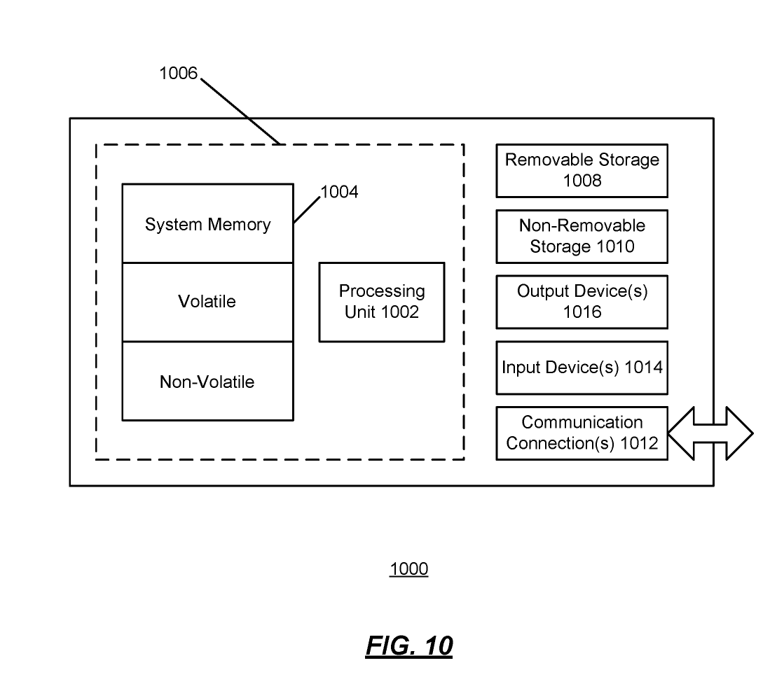

The client device 110, the route engine 160, the ride sharing service 130, and the public transportation service 140 may be implemented using a variety of computing devices such as smartphones, desktop computers, laptop computers, tablets, and video game consoles. Other types of computing devices may be supported. A suitable computing device is illustrated in FIG. 10 as the computing device 1000.

Each client device 110 may further include a route client 113. The route client 113 may receive requests for transportation 125 from a user associated with the client device 110, and in response to the request for transportation 125, may arrange transportation for the user. The request for transportation 125 may include an origin address and a destination address, and the request for transportation 125 may be a request for one or both of the ride sharing service 130 and the public transportation service 140. Examples of route clients 113 include the map applications associated with many smartphones and vehicle navigation systems, or the applications associated with ride sharing services 130 and/or public transportation services 140.

The ride sharing services 130 may include a variety of services where users are able to request a vehicle to take the users from an origin address to one or more destination addresses. Typically, these services provide users with fare estimates and allow users to request different classes or types of vehicles (e.g., taxis, luxury vehicles, SUVs, etc.). The fares charged by these services may be a flat rate, or may be dependent on factors such as location, distance, time-of-day, number of vehicles being requested, and the number of vehicles that are available for picking up users.

When a user generates a request for transportation 125 for a ride sharing service 130, the route client 113 may provide the request for transportation 125 to the ride sharing service 130. The ride sharing service 130 may respond with ride sharing data 135 that includes information such as an estimated fare from the origin location to the destination location, whether or not the fare is higher than normal (e.g., fare multiplier, surge pricing, or surcharge), and an estimated arrival time for the vehicle. The route client 113 may present some or all of the ride sharing data 135 to the user on the client device 110. If the user desires to request the vehicle in view of the ride sharing data 135, the route client 113 may generate a signal 169 that causes the ride sharing service 130 to dispatch the vehicle to the origin location. Depending on the implementation, the route client 113 may interact with the ride sharing service 130 using an API provided by the ride sharing service 130.

When the user generates a request for transportation 125 for a public transportation service 140 (e.g., bus service, train service, trolley service, or subway service), the route client 113 may provide the request to the public transportation service 140. The public transportation service 140 may provide public transportation data 145 that includes information such as the various routes, stops, and stations that may be used for the user to travel from the origin location to the destination location. The public transportation data 145 may further include schedule information for the routes, stops, and stations. Where available, the public transportation data 145 may also include real-time information about the status of each associated vehicle (e.g., bus or train) such as the current location and how late or ahead of schedule the vehicle is.

Depending on the implementation, rather than the public transportation service 140 identifying the various routes, stops, and stations that may be used to travel from the origin location to the destination location, the route client 113 may identify the various routes, stops, and stations from the public transportation data 145. For example, the public transportation data 145 may include raw data that describes all of the various routes, stops, and stations that are available in the associated public transportation system.

The route client 113, in response to the request for transportation 125, may present the user with various options that may be used by the user to go from the origin location to the destination location. For example, the route client 113 may identify bus routes, stops, and stations that the user may use to travel to the destination location. The route client 113 may further indicate the schedule associated with each route. The user may begin the trip by traveling to an indicated stop or station.

While such methods for generating and responding to requests for transportation 125 are useful, there are several drawbacks associated with such methods. One drawback is that they fail to consider the user's ability to walk (or take another transportation mode) part of the distance between the origin location and the destination location, especially where walking could save the user money and/or time spent waiting for transportation.

For example, with respect to ride sharing services 130, users typically have to wait some amount of time for a requested vehicle to arrive. This may be due to a variety of factors such as traffic or construction in the area associated with the origin location or the vehicle. However, if the user could be instructed to walk to a location that is different from the origin location, the wait for the vehicle could be reduced. Similarly, if there are conditions associated with the origin location selected by the user that is causing higher than normal fares, the user could be instructed to walk to a selected location that is not experiencing the high fares. In such scenarios, the selected location could be selected such that the user and the requested vehicle will arrive at the location at approximately the same time.

In another example, with respect to public transportation services 140, users are typically recommended the stations or stops that are closest to the origin location of the user. While this may reduce the total amount of walking (or driving or biking, for example) that is performed by the user, it may also result in the user waiting for the public transportation to arrive. The wait may be because of traffic conditions, or the irregular paths of some public transportation routes. In such scenarios, it may be desirable to recommend that the user travel to the station that will result in the lowest overall wait, even where the user travels a greater distance.

Accordingly, to solve the problems noted above, the route engine 160 may, in response to requests for transportation 125, generate instructions 165 that combine two or more modes of transportation and include a selected location between the origin location and the destination location of the request for transportation 125. The first transportation mode may be a transportation mode associated with the user such as walking, biking, or driving a car. The second transportation mode may be the transportation mode associated with the public transportation service 140 or the ride sharing service 130. The instructions 165 may instruct the user to take the first transportation mode to the selected location from the origin location, and to take the second transportation mode to the destination location. The route engine 160 may select the location that minimizes one or more of the total time spent traveling, the total time spend waiting, or the total cost of the trip, for example.

Depending on the implementation, the route engine 160 may generate the instructions 165 for a user using one or more user profiles 175 stored in user profile data 170. The user profile 175 may describe the various preferences of the user with respect to the first mode of transportation. For example, where the first mode of transportation is walking, the user profile 175 may include, for example, the relative speed of the user, a maximum distance that the user will walk (e.g., less than one mile), weather related preferences (e.g., will not walk in the rain or snow, and will not walk when the temperature is above 90 F or below 30 F), time related preferences (e.g., will not walk at night or very early morning), and cost related preferences (e.g., only walk when fare is above $15, or when fare multiplier is above x %). Other information may be stored in the user profile 175. For purposes of brevity, in the examples that follow, the first mode of transportation of the user will be assumed to be walking. However, other transportation modes may be associated with the user such as running, biking, swimming, and driving, for example.

With respect to the ride sharing service 130, the route client 113 may provide the request for transportation 125 received from a user to the route engine 160. The route engine 160 may retrieve the user profile 175 of the user from the user profile data 170. The route engine 160 may determine a plurality of locations that are different than either the origin location or the destination location that are associated with the request for transportation 125. These locations may be the intermediate or alternative locations that the user may be asked to walk to. The determined locations may be determined from a set of known locations or intersections using criteria from the user profile 175. For example, the user profile 175 may include a maximum walking distance, and the determined plurality of locations may all be locations that are less than the maximum distance.

After determining the plurality of locations, the route engine 160 may request ride sharing data 135 from the ride sharing service 130 for each location of the determined plurality of locations. The ride sharing data 135 may, for each determined location, include a fare for a ride from the determined location to the destination location of the request for transportation 125, and an expected arrival time for a vehicle at the determined location. In addition, the route engine 160 may use the user profile 175 to determine how long it will take the user to arrive at each of the determined locations.

The route engine 160 may select one of the determined locations based on the ride sharing data 135 and how long it will take the user to arrive at each location. In some implementations, the route engine 160 may select the location that will result in the user spending the least amount of time waiting at the selected location, may select the location that will result in the lowest cost ride, or some combination of both.

Depending on the implementation, after selecting the location, the route engine 160 may generate and display instructions 165 for the user to walk to the selected location at the route client 113. The instructions 165 may include information such as when the user should leave, how long the walk will take, when the vehicle will arrive at the location, and the cost of the trip. Alternatively, the route engine 160 may display instructions 165 for the original route (i.e., the route between the origin location and the destination location of the request for transportation 125) along with an offer 167 that includes the selected location. The user may select the offer 167 by generating an acceptance 127 using the route client 113, or may reject the offer by generating a rejection 129 using the route client 113.

After the user accepts or rejects the offer 167 to travel to the selected location, the route engine 160 may arrange for the dispatching of a vehicle with the ride sharing service 130. If the user accepts the offer 167, the route engine 160 may generate and provide a signal 169 for the ride sharing service 130 to dispatch a vehicle to the selected location. If the user does not accept the offer 167, the route engine 160 may generate and provide a signal 169 for the ride sharing service 130 to dispatch a vehicle to the origin location of the request for transportation 125.

With respect to the public transportation service 140, the route client 113 may provide the request for transportation 125 received from a user to the route engine 160. The route engine 160 may retrieve the user profile 175 of the user from the user profile data 170. The route engine 160 may determine, using the public transportation data 145, one or more routes (e.g., bus routes or train lines) that the user can take to get from the origin location to the destination location of the request for transportation 125.

Based on the determined one or more lines and the public transportation data 145, the route engine 160 may determine a plurality of locations. The locations may correspond to stops on the determined one or more routes. Depending on the implementation, the determination may also consider the user profile 175 associated with the user. For example, the locations may all be within the maximum walking distance of the user as defined in the user profile 175.

After determining the plurality of locations, the route engine 160 may use the public transportation data 145 to determine the time when the associated public transportation vehicle will arrive at each location. Depending on the implementation, the times may be determined based on schedule data, or based on real-time information about the timeliness or location of each public transportation vehicle. In addition, the route engine 160 may use the user profile 175 to determine how long it will take the user to arrive at each of the determined locations.

The route engine 160 may select one of the determined locations based on the times when the public transportation vehicles will arrive at each location and how long it will take the user to arrive at each location. In some implementations, the route engine 160 may select the location that will result in the user spending the least amount of time waiting at the selected location, or may select the location that will result in the user walking the shortest overall distance.

After selecting the location, the route engine 160 may generate and display instructions 165 for the user to walk to the selected location at the route client 113. The instructions 165 may include information such as when the user should leave, how long the walk will take, when the vehicle will arrive at the location, and/or the cost of the trip, for example. Alternatively, the route engine 160 may display multiple locations along with an estimated arrival time (and estimated walk times, for example), and ask the user to select the preferred location.

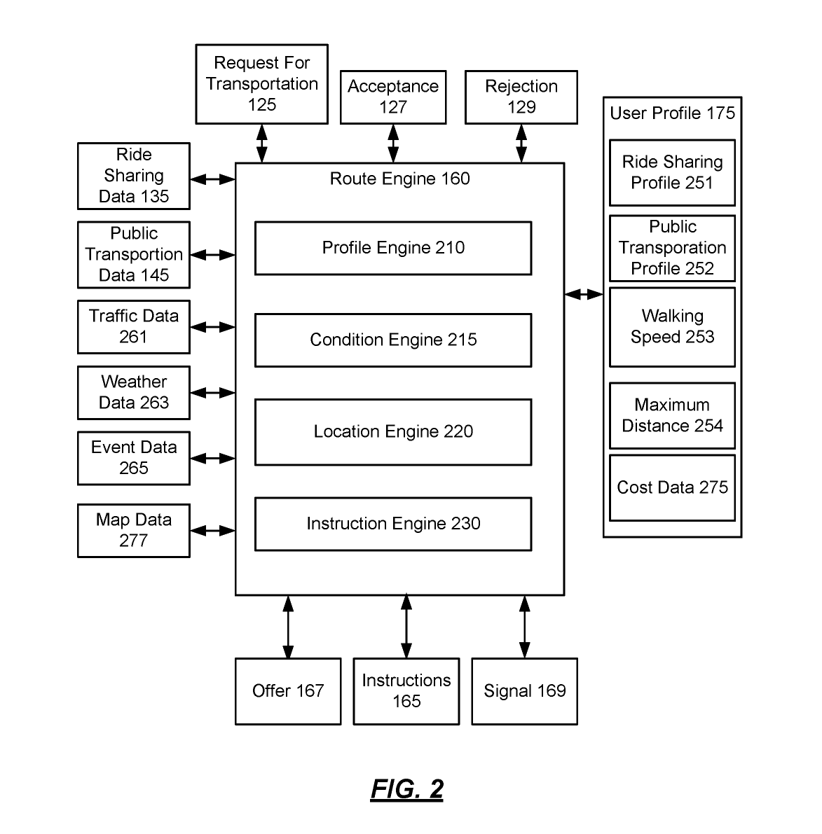

FIG. 2 is an illustration of an implementation of an exemplary route engine 160. The route engine 160 may include one or more components including a profile engine 210, a condition engine 215, a location engine 220, and an instruction engine 230. More or fewer components may be included in the route engine 160. Some or all of the components of the route engine 160 may be implemented by one or more computing devices such as the computing device 1000 described with respect to FIG. 10.

The profile engine 210 may generate and/or maintain user profiles 175. The user profile associated with a user may be used by the route engine 160 to determine under what conditions the user would like to be recommended intermediate or alternative locations when generating a request for transportation 125, and which locations to select and present to the user.

As may be appreciated, the user profiles 175 may be personal and private. Accordingly, to protect the privacy of the user, all of the user profile 175 may be encrypted. Moreover, before any data associated with the user profile 175 is collected, generated, or used by the profile engine 210 (or any other component of the route engine 160), the user may be asked to opt-in or otherwise consent to the use of such data.

The profile engine 210 may generate the user profile 175 to include a ride sharing profile 251. The ride sharing profile 251 may identify one or more ride sharing services 130 used by the user, and may include account information such as user names and/or passwords that may be used to access each ride sharing service 130. Other information such as payment information may also be included in the ride sharing profile 251. Depending on the implementation, the profile engine 210 may request some or all of the ride sharing profile 251 from a user of the route client 113.

The profile engine 210 may generate the user profile 175 to include a public transportation profile 252. The public transportation profile 252 may identify one or more public transportation services 140 used by the user, and may include information such as the preferred public transportation vehicle of the user (e.g., bus, subway, train, etc.), and whether or not the user is associated with a fare pass (e.g., daily, weekly, monthly pass, etc.). Other information such as whether the user is willing to transfer, or a maximum number of transfers that will be considered by the user, may also be included. Depending on the implementation, the profile engine 210 may request some or all of the public transportation profile 252 from a user of the route client 113.

The profile engine 210 may generate the user profile 175 to include a walking speed 253. The walking speed 253 may be an estimate of how fast the user associated with the user profile 175 walks. In some implementations, the walking speed 253 may be provided by the user using the route client 113. For example, the user may provide an estimate of their walking speed or may be asked to characterize their walking speed by selecting options such as “slow”, “average”, “fast”, “very fast.”

Alternatively or additionally, the profile engine 210 may generate the walking speed 253 using the client device 110 associated with the user. For example, the route client 113 may interface with a GPS, an accelerometer, or another sensor or combination of sensors of the client device 110, to measure the walking speed 253 of the user over some period of time. The walking speed 253 may be updated periodically to ensure that the walking speed 253 continues to represent the walking speed 253 of the user.

The profile engine 210 may generate the user profile 175 to include a maximum distance 254. The maximum distance 254 may be the maximum distance that the user associated with the user profile 175 is willing to walk. Depending on the implementation, the profile engine 210 may request the maximum distance 254 from the user associated with the user profile 175, or may determine the maximum distance 254 based on user behavior. There may be a single maximum distance 254, or there may be multiple maximum distances 254 that are each associated with different conditions. For example, a user may have one maximum distance 254 that applies when the weather is good, and another that applies when the weather is bad (e.g., raining, snowing, etc.). Other conditions may include the time of day, the day of the week, and the temperature, for example.

The profile engine 210 may generate the user profile 175 to include cost data 275. The cost data 275 may reflect the preferences of the user with respect to the cost of transportation. For example, the cost data 275 may include a maximum fare that the user is willing to consider for ride sharing, and a maximum multiplier or fare increase that the user is willing to consider. Depending on the implementation, the profile engine 210 may request the cost data 275 from the user associated with the user profile 175, or may determine the cost data 275 based on user behavior. Like the maximum distance 254, the cost data 275 may be dependent on conditions. For example, the user may be willing to consider a higher fare when the weather is bad, or when it is late at night.

The condition engine 215 may determine if a condition is associated with a request for transportation 125. A condition may indicate that the origin location of the request for transportation 125 may be difficult for a ride sharing vehicle, or public transportation vehicle, to access. Conditions may lead to possible delays (i.e., increased wait time), or costs (i.e., higher fare). The conditions may include traffic conditions, event conditions, weather conditions, and high cost conditions. Other conditions may be supported.

A traffic condition may indicate that an area where the origin location is located is experiencing gridlock, construction, an accident, or any other activity that may be causing delays or may be impeding the flow of vehicles. Depending on the implementation, the condition engine 215 may determine that a request for transportation 125 is associated with a traffic condition using traffic data 261 received from one or more traffic reporting agencies, or collected from one or more other route clients 113. A request for transportation 125 may be associated with a traffic condition if the origin address is within an area indicated to have traffic by the traffic data 261.

An event condition may indicate that an area where the origin location is located is associated with an event such as a concert, sporting event, street fair, etc. Events may lead to traffic jams or a large number of users trying to use the ride sharing service 130 (or public transportation service 140), which may increase fare multipliers and wait times. Depending on the implementation, the condition engine 215 may determine that a request for transportation 125 is associated with an event condition using event data 265 received from one or more news agencies, or collected from one or more other route clients 113.

A weather condition may indicate that an area where the origin location is located is associated with a weather event. A weather event may include a storm, snow, sleet, tornado, flash flood, or any other weather related activity that may increase an expected wait time or fare multiplier of a public transportation service 140 or ride sharing service 130. Depending on the implementation, the condition engine 215 may determine that a request for transportation 125 is associated with a weather condition using weather data 263 received from one or more weather reporting services, or collected from one or more other route clients 113.

A high cost condition may indicate that an area where the origin location is located is currently experiencing a fare multiplier or other fare increasing condition (e.g., surge pricing). Depending on the implementation, the condition engine 215 may determine that a request for transportation 125 is associated with a high cost condition using the ride sharing data 135.

The location engine 220 may select one or more locations for a request for transportation 125. Where the request for transportation 125 is a request for a vehicle associated with a ride sharing service 130, the selected one or more locations may be locations that are different than both the origin location and the destination location associated with the request for transportation 125. The selected one or more locations may be locations that the user may be expected to walk to from the origin location. Where the request for transportation 125 is a request for public transportation provided by a public transportation service 140, the selected one or more locations may be stops or stations that are close to the origin location associated with the request for transportation 125. The number of locations selected by the location engine 220 may be based on user preferences from the user profile 175. In some implementations, only a single location may be selected.

In some implementations, the location engine 220 may select the one or more locations by determining a plurality of candidate locations. Where the request for transportation 125 is a request for a vehicle associated with a ride sharing service 130, the plurality of candidate locations may be determined by the location engine 220 based on one or more of the request for transportation 125, ride sharing data 135, the user profile 175, and map data 277. The map data 277 and the ride sharing data 135 may be used by the location engine 220 to determine candidate locations that are accessible to the origin location and the destination location of the request for transportation 125 by the user and the ride sharing service 130. The user profile 175 may be used by the location engine 220 to select a plurality of locations that are within the maximum distance 254 and that conform to any weather or time related constraints associated with the user. For example, the user may not be willing to walk as far in the rain, at night, or when it is cold.

Where the request for transportation 125 is a request for a public transportation service 140, the plurality of locations may be determined by the location engine 220 based on one or more of the request for transportation 125, public transportation data 145, the user profile 175, and map data 277. The map data 277 and the public transportation data 145 may be used by the location engine 220 to determine stops or stations of the public transportation service 140 that are accessible from the origin location. The user profile 175 may be used by the location engine 220 similarly as described above.

After determining the plurality of locations, the location engine 220 may select the one or more locations from the determined plurality of locations. Where the request for transportation 125 is a request for a vehicle associated with a ride sharing service 130, the location engine 220 may select the one or more locations by minimizing one or more of an expected cost of the ride using the ride sharing service 130 from the location, an expected wait time for the user at the location, a total time spent traveling for the user, and a distance between the origin location and the selected location. The factors the location engine 220 considers when selecting the one or more locations may be set by the user and represented by the user profile 175 associated with the user.

The expected cost and expected wait time for each of the determined locations may be determined by the location engine 220 from the ride sharing data 135. For example, the location engine 220 may request a fare and an arrival estimate from the ride sharing service 130 using the ride sharing profile 251 from the user profile 175. The distances between the origin location and each of the determined locations may be determined using the map data 277, and may be used in combination with the walking speed 253 of the user to estimate the arrival time for the user at each of the locations.

Where the request for transportation 125 is a request for a public transportation service 140, the location engine 220 may similarly select the one or more locations (e.g., stops) by minimizing one or more of an expected wait time for the user waiting at each location, a total time spent traveling for the user, and a distance between the origin location and the selected location.

The expected wait time for each of the determined locations may be determined by the location engine 220 from the public transportation data 140. For example, the location engine 220 may determine when the associated public transportation vehicle is scheduled to stop at each location. The estimated arrival time for the user at each location may be determined as described above

In some implementations, the location engine 220 may select locations for each received request for transportation 125. Alternatively, the location engine 220 may only select locations for requests for transportation 125 that are associated with a condition as determined by the condition engine 215. The location engine 220 may select the locations from the plurality of locations that are not also associated with the condition (or another condition).

For example, with respect to ride sharing, the condition engine 215 may determine that the origin location of the request for transportation 125 is in an area with a traffic condition. The location engine 220 may determine the plurality of locations from areas that are not experiencing the traffic condition as indicated by the traffic data 261. In another example, the condition engine 215 may determine from the ride sharing data 135 that the origin location is in an area associated with a high cost condition. The location engine 220 may determine the plurality of locations from areas that are not experiencing the high cost condition as indicated by the ride sharing data 135.

In some implementations, the location engine 220 may select locations whenever the condition engine 215 determines that the request for transportation 125 is associated with a condition. Alternatively, when a condition is detected by the condition engine 215, the location engine 220 may cause the route client 113 to alert the user regarding the condition, and may prompt or ask the user if they want to consider locations other than the origin location (or locations close to the origin location). If the user selects an option associated with considering the other locations, the location engine 220 may select one or more locations as described above. Otherwise, the route engine 160 may arrange for transportation for the user using the original origin location and destination location from the request for transportation 125.

The instruction engine 230 may generate an offer 167 using the selected locations. The offer 167 may indicate each of the selected locations and may provide information or statistics about each location such as an expected travel time to each location, an estimated wait time for each location, and an expected cost for a trip using each location. Other information may be provided such as when the user should leave their current location depending on which location they select. The offer 167 may be displayed to the user on the client device 110 by the route client 113.

The offer 167 may be displayed by the route client 113 with functionality that allows the user to accept one of the displayed selected locations or reject the displayed selected locations. If the user chooses one of the displayed selected locations, the route client 113 may generate an acceptance 127 that indicates the location that was chosen. If the user does not choose any of the displayed selected locations, the route client 113 may generate a rejection 129. The generated acceptance 127 or rejection 129 may be provided by the route client 113 to the instruction engine 230.

The instruction engine 230 may generate instructions 165 in response to the received acceptance 127 or rejection 129. For an acceptance 127, the instructions 165 may include instructions for the user to travel from the origin location of the request for transportation 125 to the accepted location using a first transportation mode (e.g., walk). The instructions 165 may further include instructions for the user to travel from the accepted location to the destination location of the request for instructions 125 using a second transportation mode (e.g., ride sharing or public transportation). The instructions 165 may be presented to the user by the route client 113 of the client device 110.

Depending on the implementation, the instructions 165 may include information such as time and distance estimates for the trip from the origin location to the accepted location and for the trip from the accepted location to the destination location, cost estimates, and wait time estimates for the user at the selected location. The instructions 165 may indicate when the user should begin the trip from the origin location to the accepted location.

For a rejection 129, the instructions 165 may include instructions for the user to travel from the origin location of the request for transportation 125 to the destination location of the request for transportation 125 using the second transportation mode (e.g., ride sharing or public transportation). The instructions 165 may be presented to the user by the route client 113 of the client device 110. The instructions 165 may include additional information as described above for the acceptance 127.

Where the request for transportation 125 is for a ride sharing service 130, after the instructions 165 are presented to the user, the instruction engine 230 may generate a signal 169 to the ride sharing service 130 to arrange for a vehicle to be dispatched to the selected location (or the origin location). The instruction engine 230 may provide the signal 169 using an API provided by the ride sharing service 130 using information from the ride sharing profile 251 of the user profile 175.

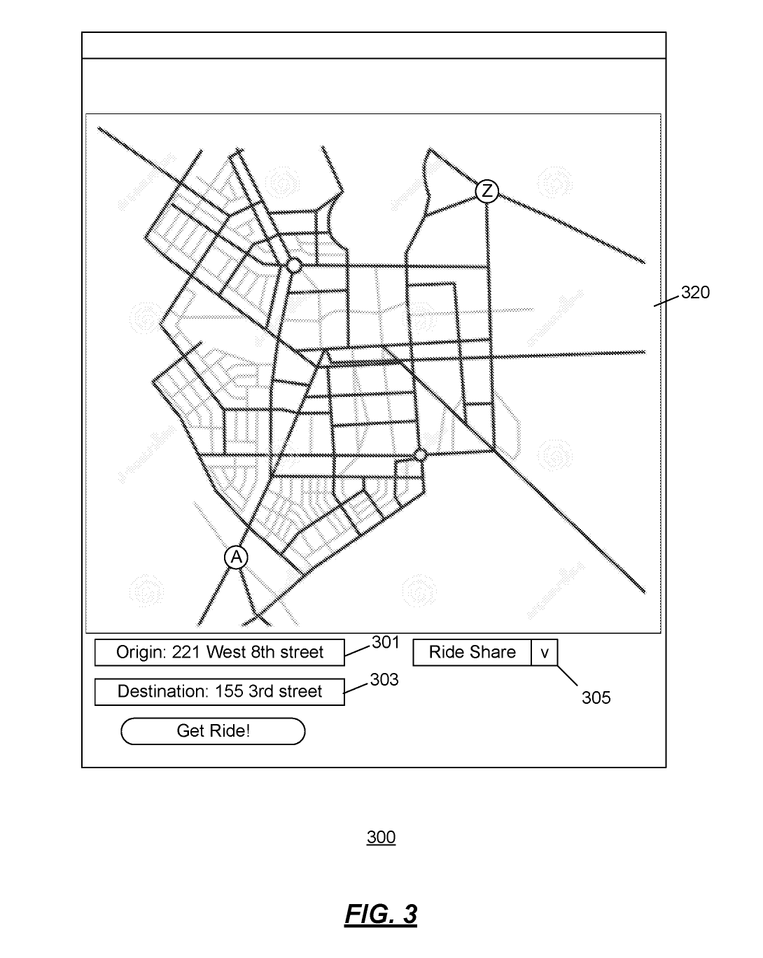

FIG. 3 is an example of a user-interface 300 through which a user can submit requests for transportation 125. The user-interface 300 may be provided by the route client 113 on a client device 110 associated with a user. As shown, the user-interface 300 includes a user-interface element 301 that the user can provide an origin location of the request for transportation 125, and a user-interface element 303 that the user can provide a destination location of the request for transportation 125. The user-interface 300 also includes a user-interface element 305 that the user can use to select between ride sharing and public transportation. In the example shown, the user has provided a request for transportation 125 that includes the origin location “221 West 8th street” and the destination location “155 3rd Street.” The origin location is illustrated on a map 320 of the user-interface 300 as the location A and the destination location is illustrated on the map 320 of the user-interface 300 as the location B.

As shown, the user has further selected the option “Ride Share” for the request for transportation 125 using the user-interface element 305. The user may submit the request for transportation 125 by selecting the button labeled “Get Ride!”.

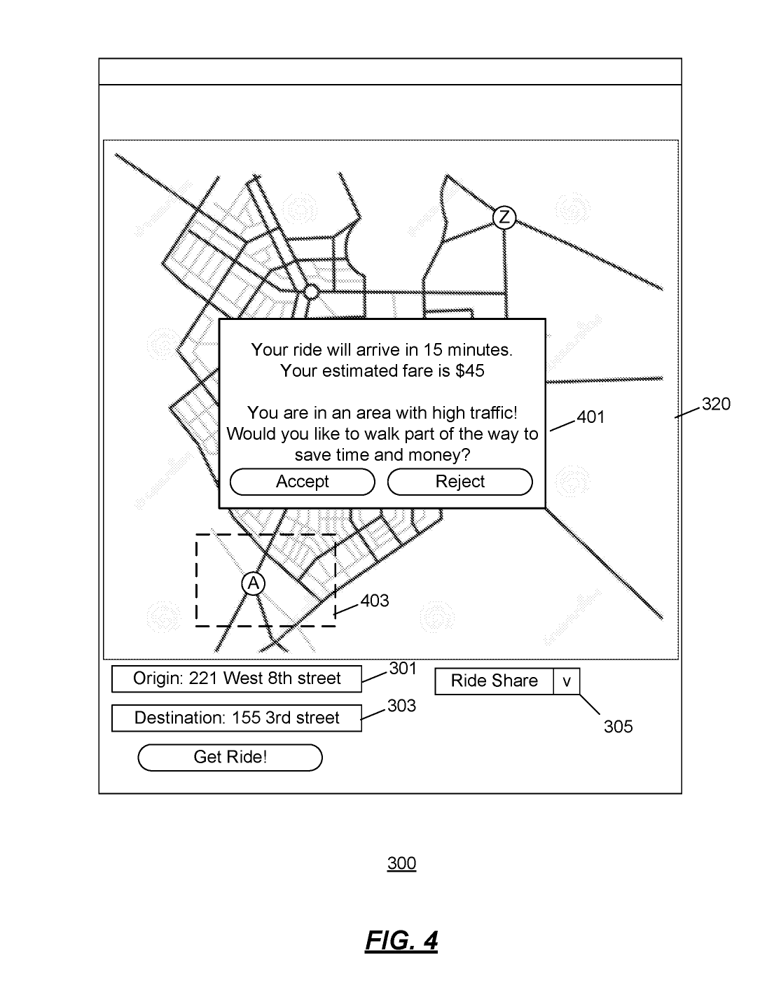

Continuing to FIG. 4, in response to the request for transportation 125, the user-interface 300 has been updated to reflect that the location A selected by the user is within an area 403 having a traffic condition. The area 403 is displayed to the user on the map 320. In addition, a window 401 is displayed in the user-interface 300 that alerts the user to the traffic associated with the location A, and includes information such as the expected arrival time for the vehicle using the ride sharing service 130, and the estimated fare. The window 401 asks the user if they would consider walking to a location that is outside of the area 403 to save time and/or money. As shown, the window 401 includes the buttons labeled “Yes” and “No” that the user can use to either accept the offer to walk to a location outside of the area 403 or decline, respectively.

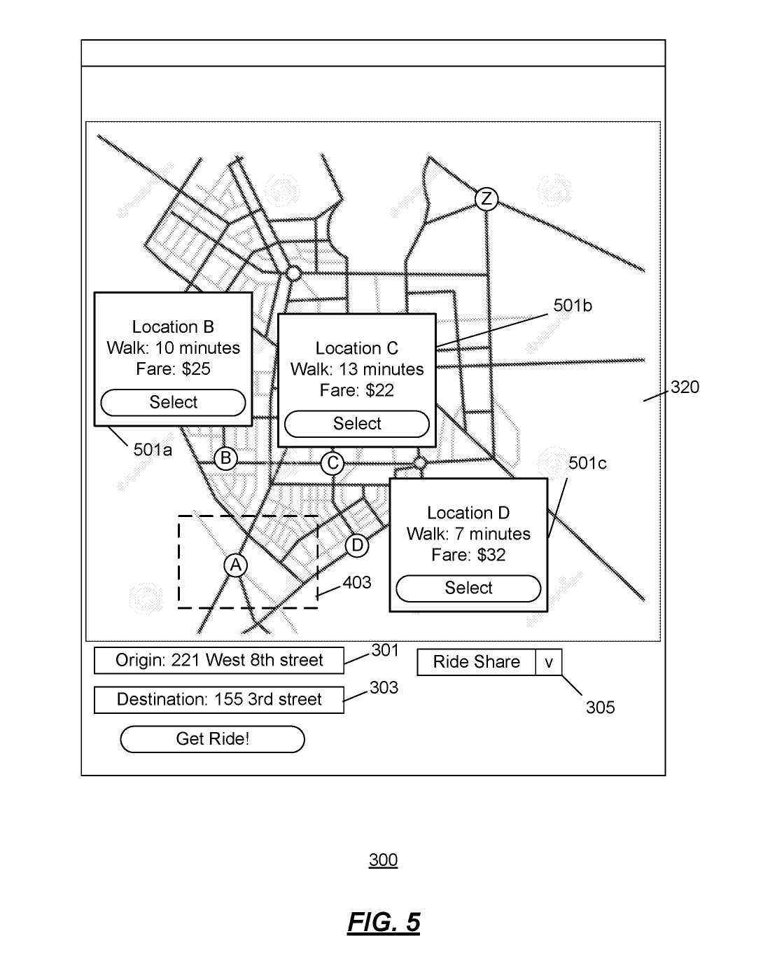

Continuing to FIG. 5, the user selected the button labeled “Yes”, and in response, the location engine 220 has selected three locations that are outside of the area 403 for the user to consider walking to. These locations are shown on the map 320 of the user-interface 300 as the location B, the location C, and the location D. In addition, for each location, the user-interface 300 has displayed a window 501 (i.e., the windows 501a, 501b, and 501c) that includes information about each location, and a button labeled “Select” that the user can use to select the associated location. For example, the window 501a is associated with the location B and includes information such as how long is the walk to the location B, and how much the ride from the location B to the location Z will cost using the ride sharing service 130. After the user selects the button labeled “Select” in one of the windows 501, the route engine 160 may arrange to have a vehicle dispatched to the associated location, and may present the user with instructions 165 to walk to the associated location in the user-interface 300.

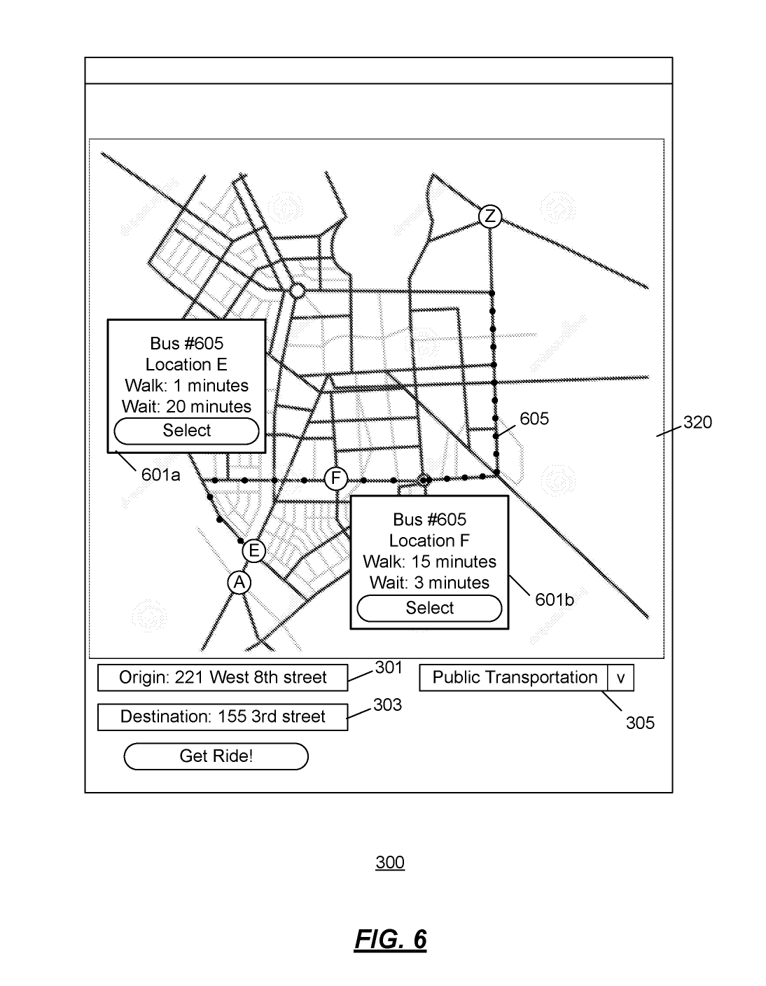

Continuing to FIG. 6, as another example, assume that the user had selected the option “Public Transportation” for the request for transportation 125 in the user-interface element 305. Accordingly, in response to the request for transportation 125, the user-interface 300 has been updated to include the locations E and F selected by the location engine 220. The locations E and F may correspond to stops on the public transportation route 605 shown on the map 320 as the dotted line.

Like FIG. 5, a window 601 (i.e., windows 601a and 601b) is displayed for each of the locations E and F along with information about the associated location. For example, the window 601a is associated with the location E and provides information indicating that the walk to the location is estimated to take the user 1 minute, and that the user is expected to wait at the location for 20 minutes. The window 601b is associated with the location F and provides information indicating that the walk to the location is estimated to take the user 15 minutes, and that the user is expected to wait at the location for 3 minutes. Each window 601 further includes a button labeled “Select” that the user can use to select the preferred location.

After the user selects a preferred location, the route engine 160 may present the user with instructions 165 in the user-interface 300 to walk to the associated location. The instructions 165 may further include a time when the user should begin the trip. For example, if the user selects the location E, the instructions 165 may give the user the option to delay the trip for 20 minutes, rather than wait at the location E for the bus 605.

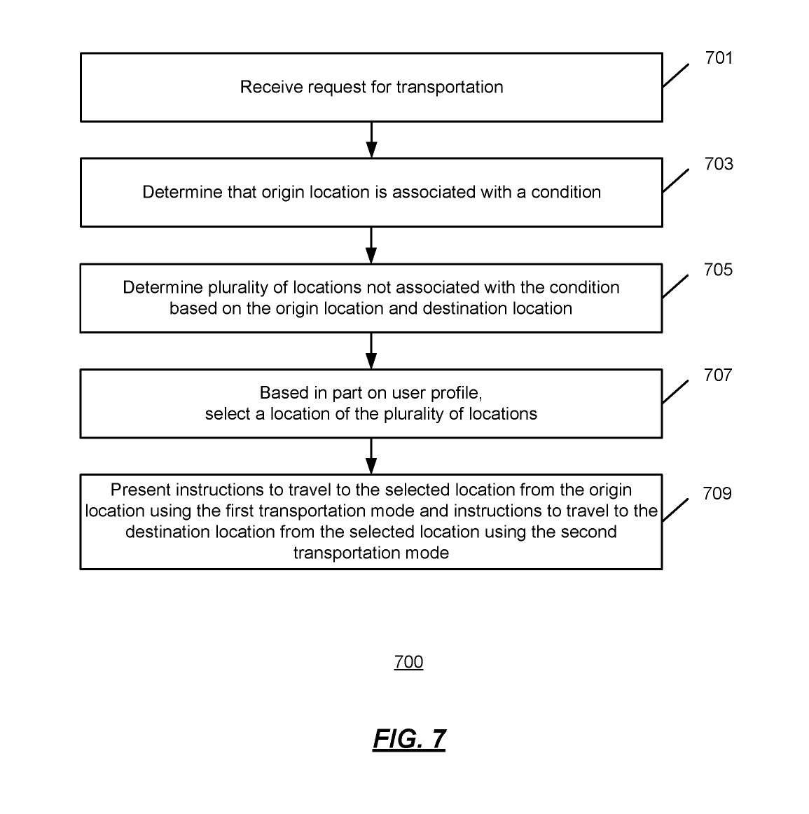

FIG. 7 is an operational flow of an implementation of a method 700 for presenting instructions in response to a request for transportation. The method 700 may be implemented by the route engine 160.

At 701, a request for transportation is received. The request for transportation 125 may be received by the route engine 160 from a device such as the client device 110. The request for transportation 125 may include an origin location and a destination location. The origin location may be a current location of a user associated with the device. The destination location may be a location that the user would like to travel to. The request for transportation 125 may be a request for one or more of a ride sharing service 130 or a public transportation service 140.

At 703, it is determined that the origin location is associated with a condition, e.g., by the condition engine 215 of the route engine 160. The origin location may be associated with a condition when it is located within an area having one or more of a traffic condition, a weather condition, an event condition, or a high cost condition. Other conditions may be supported.

At 705, a plurality of locations not associated with the condition is determined based on the origin location and the destination location. The plurality of locations not associated with the condition may be determined by the location engine 220 of the route engine 160. The plurality of locations may be locations that are outside of the area having the condition associated with the origin location. In addition, the plurality of locations may be locations that are not also themselves associated with conditions that are different than the condition associated the origin location. The plurality of locations may be selected based on map data 277, and may be locations that are within a reasonable distance from the origin location, or within a maximum distance 254 of the origin location. The maximum distance 254 may be specified in a user profile 175 associated with the user of the device.

Each location of the plurality of locations may be accessible from the origin location by the user using a first mode of transportation. The first transportation mode may be walking, for example. Other modes may be supported. The destination location may be accessible from each location of the plurality of locations using a second mode of transportation. The second mode of transportation may be a vehicle associated with a ride sharing service 130 or a vehicle associated with a public transportation service 140. Other modes of transportation may be supported.

At 707, based in part on a user profile, a location of the plurality of locations is selected. The location of the plurality of locations may be selected by the location engine 220 of the route engine 160. Depending on the implementation, the location may be selected using a function that minimizes one or more of an amount of time spent traveling by the user, an amount of time spent waiting by the user to the selected location, a total cost of the trip for the user, and a distance traveled using the first mode of transportation. The function may use information from the user profile 175 such as the walking speed 253 of the user, as well as ride sharing data 135 and/or public transportation data 145 regarding each location of the plurality of locations. For example, the ride sharing data 135 for a location may include the estimated arrival time for a vehicle of the ride sharing service 130 at the location, and an estimated cost for the trip from the location to the destination address. The public transportation data 145 for a location may include a schedule for the route or line associated with the location, and may include the estimated arrival time for a vehicle of the public transportation service 140 at the location. Other information may be included.

At 709, instructions to travel to the selected location are presented. The instructions 165 may be presented by the instruction engine 230 of the route engine 160 to the user at the device. The instructions 165 may include instructions for the user to travel to the selected location from the origin location using the first transportation mode and instructions for the user to travel to the destination location from the selected location using the second transportation mode. The instructions 165 may further include information such as an amount of time that the user may wait at the selected location for the second mode of transportation, and may indicate when the user should leave for the selected location. Other information may be included in the instructions 165.

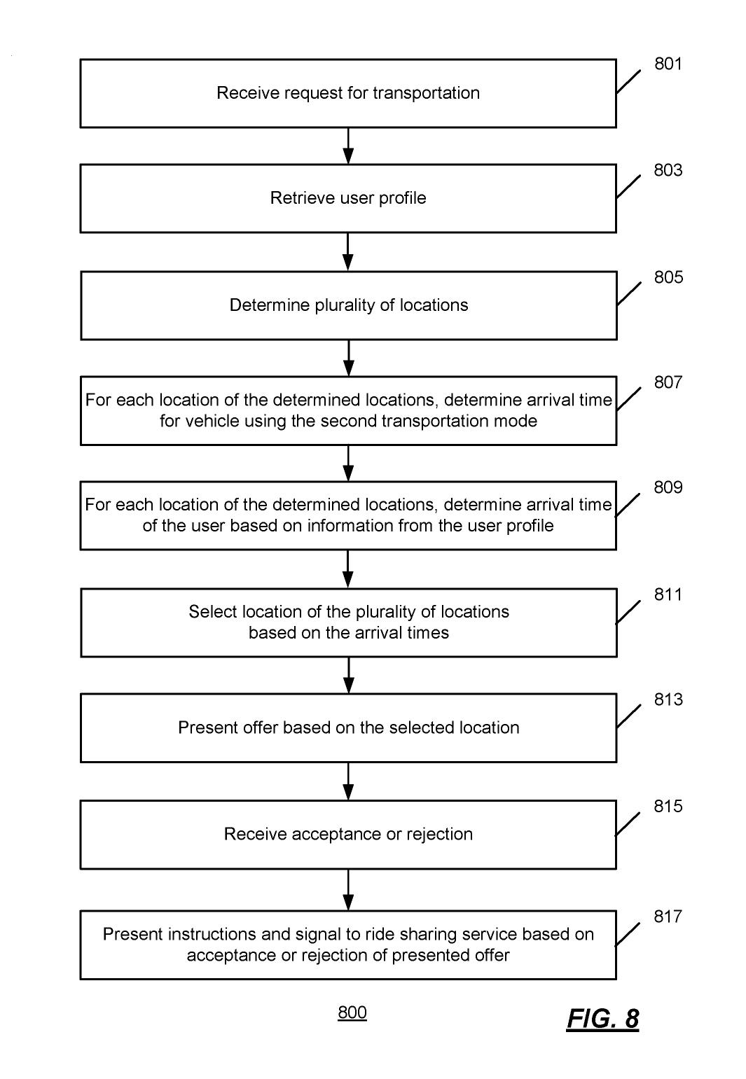

FIG. 8 is an operational flow of an implementation of a method 800 for presenting instructions in response to a request for transportation. The method 800 may be implemented by the route engine 160.

At 801, a request for transportation is received. The request for transportation 125 may be received by the route engine 160 from a device such as the client device 110. The request for transportation 125 may include an origin location and a destination location. The request for transportation 125 may be a request for one or more of a ride sharing service 130 or a public transportation service 140.

At 803, a user profile is retrieved. The user profile 175 may be retrieved by the route engine 160 from the user profile data 170. The user profile 175 may include a variety of information about the user associated with the user profile 175 such as a maximum distance 254 from the origin location that the user will consider, preferences related to weather and the time of day, a ride sharing profile 251 associated with user, a public transportation profile 252 associated with the user, and a walking speed 253 associated with the user. The walking speed 253 may have been specified by the user, or determined by the route engine 160 based on user behavior. For example, the route engine 160 may have measured the walking speed 253 using measurements from a sensor associated with the device.

At 805, a plurality of locations is determined. The plurality of locations may be determined by the location engine 220 of the route engine 160. The plurality of locations may be selected based on map data 277, and may be selected using information from the user profile 175 associated with the user. For example, the location engine 220 may use the maximum distance 254 from the origin location that the user will consider, as well as other preferences related to weather and the time of day when determining the plurality of locations.

At 807, for each location of the determined locations, an arrival time for a vehicle using the second transportation mode is determined. The arrival time for a vehicle may be determined by the location engine 220 from ride sharing data 135 and/or public transportation data 145. For example, where the second transportation mode is a vehicle associated with a ride sharing service 130, the location engine 220 may query the ride sharing service 130 for an estimated arrival time and fare for a vehicle at the location using a ride sharing profile 251 from the user profile 175. The ride sharing service 130 may respond to the query with ride sharing data 135 that includes the requested information.

Where the second transportation mode is a vehicle associated with a public transportation service 140, the location engine 220 may query the public transportation service 140 for a schedule for the location using a public transportation profile 252 from the user profile 175. The public transportation service 140 may respond to the query with public transportation data 145 that includes the requested information.

At 809, for each location of the determined locations, an arrival time of the user is determined based on information from the user profile. The arrival time for the user at a location may be determined for the user by the location engine 220 of the route engine 160 using the walking speed 253 of the user from the user profile 175.

At 811, a location of the plurality of locations is selected based on the arrival times. The location may be selected by the location engine 220 of the route engine 160 by, for each location, determining a difference between the arrival time of the vehicle at the location and the arrival time of the user at the location. The location with the minimum difference may be selected by the location engine 220. Other factors may also be considered when selecting the location, such as minimizing a total cost of the trip, and minimizing a distance or time spent walking by the user.

At 813, an offer is presented based on the selected location. The offer 167 may be presented by the instruction engine 230 of the route engine 160. The offer 167 may be an offer for the user to consider traveling to the selected location from the origin location using the first mode of transportation, and traveling from the selected location to the destination location using the second mode of transportation. The offer 167 may include information such as the amount of time and/or money that may be saved by the user using the selected location versus traveling from the origin location to the destination using only the second mode of transportation.

At 815, an acceptance or a rejection of the presented offer is received. The acceptance 127 or rejection 129 may be received by the instruction engine 230 of the route engine 160. Depending on the implementation, the user may generate the acceptance 127 or rejection 129 using a user-interface presented on a route client 113 associated with the device.

At 817, instructions are presented based on the acceptance or rejection of the presented offer. The instructions 165 may be presented by the instruction engine 230 to the user of the device. For an acceptance 127, the instructions 165 may include instructions for the user to travel to the selected location from the origin location using the first transportation mode and instructions for the user to travel to the destination location from the selected location using the second transportation mode. For a rejection, the instructions 165 may include instructions for the user to travel to the destination location from the origin location using the second transportation mode.

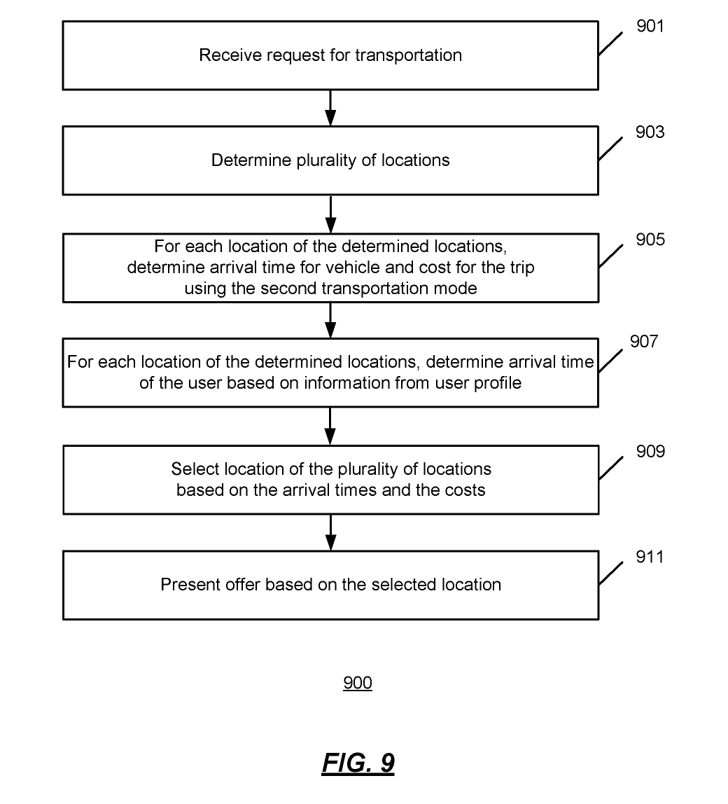

FIG. 9 is an operational flow of an implementation of a method 900 for presenting an offer in response to a request for transportation. The method 900 may be implemented by the route engine 160.

At 901, a request for transportation is received. The request for transportation 125 may be received by the route engine 160 from a device such as the client device 110. The request for transportation 125 may include an origin location and a destination location. The request for transportation 125 may be a request for one or more of a ride sharing service 130 or a public transportation service 140.

At 903, a plurality of locations is determined. The plurality of locations may be determined by the location engine 220 of the route engine 160. The plurality of locations may be selected based on map data 277, and may be selected using information from a user profile 175 associated with the user.

At 905, for each location of the determined locations, an arrival time for a vehicle using the second transportation mode and a cost for the trip from the location to the destination location is determined. The arrival time for a vehicle and the cost for the trip may be determined by the location engine 220 from ride sharing data 135. For example, where the second transportation mode is a vehicle associated with a ride sharing service 130, the location engine 220 may query the ride sharing service 130 for an estimated arrival time and cost using a ride sharing profile 251 from the user profile 175. The ride sharing service 130 may respond to the query with ride sharing data 135 that includes the requested information.

At 907, for each location of the determined locations, an arrival time of the user is determined based on information from the user profile. The arrival time for the user at a location may be determined for the user by the location engine 220 of the route engine 160 using the walking speed 253 of the user from the user profile 175.

At 909, a location of the plurality of locations is selected based on the arrival times and the costs. The location may be selected by the location engine 220 of the route engine 160 by, for each location, determining a difference (i.e., wait time) between the arrival time of the vehicle at the location and the arrival time of the user at the location. The location may be selected by the location engine 220 using a selection function that considers the cost and the wait times for each location. Depending on the implementation, the location engine 220 may control how the selection function weighs costs versus wait times using information from the user profile 175. For example, the user may specify whether they prefer to save time or money when creating their user profile 175. Other factors may be considered in the selection such as weather conditions and/or time of day, that may make one location preferable to another location.

At 911, an offer is presented based on the selected location. The offer 167 may be presented by the instruction engine 230 of the route engine 160. The offer 167 may be an offer for the user to consider traveling to the selected location from the origin location using the first mode of transportation, and traveling from the selected location to the destination location using the second mode of transportation.

FIG. 10 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 10, an exemplary system for implementing aspects described herein includes a computing device, such as computing device 1000. In its most basic configuration, computing device 1000 typically includes at least one processing unit 1002 and memory 1004. Depending on the exact configuration and type of computing device, memory 1004 may be volatile (such as random access memory (RAM)), non-volatile (such as read-only memory (ROM), flash memory, etc.), or some combination of the two. This most basic configuration is illustrated in FIG. 10 by dashed line 1006.

Computing device 1000 may have additional features/functionality. For example, computing device 1000 may include additional storage (removable and/or non-removable) including, but not limited to, magnetic or optical disks or tape. Such additional storage is illustrated in FIG. 10 by removable storage 1008 and non-removable storage 1010.

Computing device 1000 typically includes a variety of computer readable media. Computer readable media can be any available media that can be accessed by the device 1000 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of computing device 1000.

Computing device 1000 may contain communication connection(s) 1012 that allow the device to communicate with other devices. Computing device 1000 may also have input device(s) 1014 such as a keyboard, mouse, pen, voice input device, touch input device, etc. Output device(s) 1016 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for minimizing wait times or costs for a user in multimodal transportation scenarios is provided. The system may include at least one computing device and a route engine. The route engine may be adapted to: receive a request for transportation from a device, wherein the request includes an origin location and a destination location; determine a plurality of locations based on the origin location and the destination location, wherein each location of the plurality of locations is accessible from the origin location using a first transportation mode and the destination location is accessible from each location of the plurality of locations using a second transportation mode; based in part on a user profile, select a location of the plurality of locations; and present instructions to travel to the selected location from the origin location using the first transportation mode and instructions to travel to the destination location from the selected location using the second transportation mode.

Implementations may include some or all of the following features. The route engine may be further adapted to: determine that the origin location is associated with a condition. The route engine adapted to determine the plurality of locations based on the origin location and the destination location may include the route engine adapted to determine the plurality of locations that are not associated with the condition. The condition may include one or more of a traffic condition, a weather condition, an event condition, or a high cost condition. The route engine adapted to, based in part on the user profile, select the location of the plurality of locations may include the route engine adapted to: for each location of the determined locations, determine an arrival time at the location for a vehicle using the second transportation mode; for each location of the determined locations, determine an arrival time of the user at the location using the first transportation mode based on information from the user profile; and select the location of the plurality of locations based on the arrival times of the user and the arrival times of the vehicles. The route engine adapted to select the location of the plurality of locations based on the arrival times of the user and the arrival times of the vehicles may include the route engine adapted to select the location that minimizes a difference between the arrival time of the user and the arrival time of the vehicle. The first transportation mode may be walking, and the information from the user profile may be a walking speed of the user. The walking speed of the user may be one or more of provided by the user or determined by the route engine based on user behavior. The route engine adapted to, based in part on the user profile, select the location of the plurality of locations may include the route engine adapted to: for each of each location of the determined locations, determine an arrival time at the location for a vehicle using the second transportation mode and a cost for a trip from the location to the destination location; for each location of the determined locations, determine an arrival time of the user at the location using the first transportation mode based on information from the user profile; and select the location of the plurality of locations based on the arrival times of the user, the arrival times of the vehicles, and the costs. The route engine may be further adapted to: receive an acceptance of the presented instructions; and in response to the acceptance, provide a signal to a ride sharing service to send a vehicle to the selected location. The instructions may be provided to the ride sharing service using an application programming interface provided by the ride sharing service. The first mode of transportation may be walking, and the second mode of transportation is a vehicle associated with a ride sharing service or a vehicle associated with a public transit service.

In an implementation, a system for minimizing wait times for a user in multimodal transportation scenarios is provided. The system may include at least one computing device and a route engine. The route engine may be adapted to: receive a request for transportation, wherein the request includes an origin location and a destination location; determine a plurality of locations based on the origin location and the destination location, wherein each location of the plurality of location is accessible from the origin location using a first transportation mode and the destination location is accessible from each location of the plurality of locations using a second transportation mode; retrieve a user profile; for each of each location of the determined locations, determine an arrival time at the location for a vehicle using the second transportation mode; for each location of the determined locations, determine an arrival time of the user at the location using the first transportation mode based on information from the user profile; select a location of the plurality of locations based on the arrival times of the user and the arrival times of the vehicles; and present an offer based on the selected location, wherein the offer is for the user to travel from the origin location to the selected location using the first transportation mode and to travel from the selected location to the destination location using the second transportation mode.

Implementations may include some or all of the following features. The route engine may be further adapted to: receive an acceptance of the offer; and in response to the acceptance, present instructions to travel to the selected location from the origin location using the first transportation mode and instructions to travel to the destination location from the selected location using the second transportation mode. The route engine may be further adapted to, in response to the acceptance, provide a signal to a ride sharing service to send a vehicle to the selected location. The route engine may be further adapted to: receive a rejection of the offer; and in response to the rejection, provide a signal to a ride sharing service to send a vehicle to the origin location. The first transportation mode may be walking, and the information from the user profile may be a walking speed of the user. The walking speed of the user may be one or more of provided by the user or determined by the route engine based on user behavior.

In an implementation, a method for minimizing wait times and costs for a user in multimodal transportation scenarios is provided. The method may include: receiving a request for transportation by a computing device, wherein the request includes an origin location and a destination location; determining a plurality of locations based on the origin location and the destination location by the computing device, wherein each location of the plurality of location is accessible from the origin location using a first transportation mode and the destination location is accessible from each location of the plurality of locations using a second transportation mode; retrieving a user profile by the computing device; for each location of the determined locations, determining an arrival time at the location for a vehicle using the second transportation mode and a cost for a trip from the location to the destination location by the computing device; for each location of the determined locations, determining an arrival time of the user at the location using the first transportation mode based on information from the user profile by the computing device; selecting a location of the plurality of locations based on the arrival times of the user, the arrival times of the vehicle, and the costs by the computing device; and presenting an offer based on the selected location, wherein the offer is for the user to travel from the origin location to the selected location using the first transportation mode and to travel from the selected location to the destination location using the second transportation mode.

Implementations may include some or all of the following features. The method may further include receiving an acceptance of the offer; and in response to the acceptance, presenting instructions to travel to the selected location from the origin location using the first transportation mode and instructions to travel to the destination location from the selected location using the second transportation mode. The method may further include, in response to the acceptance, providing a signal to a ride sharing service to send a vehicle to the selected location.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for minimizing wait times or costs for a user in multimodal transportation scenarios, the system comprising:
at least one computing device; and
a route engine adapted to:
receive a request for transportation, wherein the request includes an origin location and a destination location;
determine a plurality of locations based on the origin location and the destination location, wherein each location of the plurality of locations is accessible from the origin location using a first transportation mode and the destination location is accessible from each location of the plurality of locations using a second transportation mode;
based in part on a user profile, select a location of the plurality of locations; and
present instructions to travel to the selected location from the origin location using the first transportation mode and instructions to travel to the destination location from the selected location using the second transportation mode.

2. The system of claim 1, wherein the route engine is further adapted to:
determine that the origin location is associated with a condition; and wherein the route engine adapted to determine the plurality of locations based on the origin location and the destination location comprises the route engine adapted to determine the plurality of locations that are not associated with the condition.

3. The system of claim 2, wherein the condition comprises one or more of a traffic condition, a weather condition, an event condition, or a high cost condition.

4. The system of claim 1, wherein the route engine adapted to, based in part on the user profile, select the location of the plurality of locations comprises the route engine adapted to:
for each location of the determined locations, determine an arrival time at the location for a vehicle using the second transportation mode;
for each location of the determined locations, determine an arrival time of the user at the location using the first transportation mode based on information from the user profile; and
select the location of the plurality of locations based on the arrival times of the user and the arrival times of the vehicles.

5. The system of claim 4, wherein route engine adapted to select the location of the plurality of locations based on the arrival times of the user and the arrival times of the vehicles comprises the route engine adapted to select the location that minimizes a difference between the arrival time of the user and the arrival time of the vehicle.

6. The system of claim 4, wherein the first transportation mode is walking, and the information from the user profile is a walking speed of the user.

7. The system of claim 6, wherein the walking speed of the user is one or more of provided by the user or determined by the route engine based on user behavior.

8. The system of claim 1, wherein the route engine adapted to, based in part on the user profile, select the location of the plurality of locations comprises the route engine adapted to:
for each of each location of the determined locations, determine an arrival time at the location for a vehicle using the second transportation mode and a cost for a trip from the location to the destination location;
for each location of the determined locations, determine an arrival time of the user at the location using the first transportation mode based on information from the user profile; and
select the location of the plurality of locations based on the arrival times of the user, the arrival times of the vehicles, and the costs.

9. The system of claim 1, wherein the route engine is further adapted to:
receive an acceptance of the presented instructions; and
in response to the acceptance, provide a signal to a ride sharing service to send a vehicle to the selected location.

10. The system of claim 9, wherein the instructions are provided to the ride sharing service using an application programming interface provided by the ride sharing service.

11. The system of claim 1, wherein the first mode of transportation is walking, and the second mode of transportation is a vehicle associated with a ride sharing service or a vehicle associated with a public transportation service.

12. A system for minimizing wait times for a user in multimodal transportation scenarios, the system comprising:
at least one computing device; and
a route engine adapted to:
receive a request for transportation, wherein the request includes an origin location and a destination location;
determine a plurality of locations based on the origin location and the destination location, wherein each location of the plurality of location is accessible from the origin location using a first transportation mode and the destination location is accessible from each location of the plurality of locations using a second transportation mode;
retrieve a user profile;
for each of each location of the determined locations, determine an arrival time at the location for a vehicle using the second transportation mode;
for each location of the determined locations, determine an arrival time of the user at the location using the first transportation mode based on information from the user profile;
select a location of the plurality of locations based on the arrival times of the user and the arrival times of the vehicles; and
present an offer based on the selected location, wherein the offer is for the user to travel from the origin location to the selected location using the first transportation mode and to travel from the selected location to the destination location using the second transportation mode.

13. The system of claim 12, wherein the route engine is further adapted to:
receive an acceptance of the offer; and
in response to the acceptance, present instructions to travel to the selected location from the origin location using the first transportation mode and instructions to travel to the destination location from the selected location using the second transportation mode.

14. The system of claim 13, wherein the route engine is further adapted to, in response to the acceptance, provide a signal to a ride sharing service to send a vehicle to the selected location.

15. The system of claim 12, wherein the route engine is further adapted to:
receive a rejection of the offer; and
in response to the rejection, provide a signal to a ride sharing service to send a vehicle to the origin location.

16. The system of claim 12, wherein the first transportation mode is walking, and the information from the user profile is a walking speed of the user.

17. The system of claim 16, wherein the walking speed of the user is one or more of provided by the user or determined by the route engine based on user behavior.

18. A method for minimizing wait times and costs for a user in multimodal transportation scenarios, the method comprising:
receiving a request for transportation by a computing device, wherein the request includes an origin location and a destination location;
determining a plurality of locations based on the origin location and the destination location by the computing device, wherein each location of the plurality of location is accessible from the origin location using a first transportation mode and the destination location is accessible from each location of the plurality of locations using a second transportation mode;
retrieving a user profile by the computing device;
for each location of the determined locations, determining an arrival time at the location for a vehicle using the second transportation mode and a cost for a trip from the location to the destination location by the computing device;
for each location of the determined locations, determining an arrival time of the user at the location using the first transportation mode based on information from the user profile by the computing device;
selecting a location of the plurality of locations based on the arrival times of the user, the arrival times of the vehicle, and the costs by the computing device; and
presenting an offer based on the selected location, wherein the offer is for the user to travel from the origin location to the selected location using the first transportation mode and to travel from the selected location to the destination location using the second transportation mode.

19. The method of claim 18, further comprising:
receiving an acceptance of the offer; and
in response to the acceptance, presenting instructions to travel to the selected location from the origin location using the first transportation mode and instructions to travel to the destination location from the selected location using the second transportation mode.

20. The method of claim 19, further comprising, in response to the acceptance, providing a signal to a ride sharing service to send a vehicle to the selected location.
